(19) United States
(12) Patent Application Publication
(10) Pub. No.: US 2001/0004074 A1
(43) Pub. Date: Jun. 21, 2001

(54) Exothermic body and method of making same

(76) Inventor: Katsuyuki Uchida, Shiga (JP)

Correspondence Address: COUDERT BROTHERS, Suite 3300, Four Embarcadero Center, San Francisco, CA, 94111, US

(21) Appl. No.: 09/771,483

(22) Filed: Jan. 25, 2001

Related U.S. Application Data
(62) Division of application No. 09/213,020, filed on Dec. 16, 1998.
Application No. 09/213,020 is a continuation-in-part of application No. 08/792,777, filed on Feb. 3, 1997, now abandoned.

(30) Foreign Application Priority Data
Mar. 6, 1996 (JP) 8-048962

(51) Int. Cl. H05B 3/00

(52) U.S. Cl. 219/505; 219/541; 338/313; 338/327; 338/332; 338/22 R

(57) ABSTRACT

An exothermic body, capable of efficiently conducting heat from a planar thermistor element with positive temperature characteristic, has a pair of comb-shaped electrodes formed by a sputtering or plating method with thickness less than 10 μm on one of main surfaces of the thermistor element.

This is a continuation-in-part of application Ser. No. 08/792,777 filed Feb. 3, 1997, to be abandoned.

### BACKGROUND OF THE INVENTION

This invention relates to an exothermic body capable of a high-power output for use, for example, as a thermal load by boiling water and a method of producing such a body.

FIGS. 7 and 8 will be referenced first to describe a prior art exothermic body 1 of this type and a heater 7 using such an exothermic body. As shown in FIG. 7, the exothermic body 1 comprises a thermistor element 2 with a positive temperature characteristic, a pair of comb-shaped electrodes 3 and 4 formed on one of its main surfaces, and terminal electrodes 5 and 6 formed on side surfaces and the other of the main surfaces of the thermistor element 2 and electrically connected respectively to the comb-shaped electrodes 3 and 4 for facilitating the supply of electric power to the latter The comb-shaped electrodes 3 and 4 are formed by applying an electro-conductive paste, such as a paste having silver as its main component, on one main surface of the thermistor element 2 and baking it to form ohmic contacts.

As shown in FIG. 8, the heater 7 is formed by placing an insulating plate 8 and a heat radiating member 9 sequentially on the main surface of the thermistor element 2 on which are formed the comb-shaped electrodes 3 and 4. Power-feed terminals (not shown) may be additionally provided to electrically connect to the terminal electrodes 5 and 6. The insulating plate 8 is a thin plate comprising an insulative material, making a surface contact with the comb-shaped electrodes 3 and 4 on the thermistor element 2 for insulating the heat radiating member 9 therefrom. The heat radiating member 9 comprises a metallic plate such as an aluminum plate having high thermal conductivity, making a surface contact with the insulating plate 8.

With an exothermic body thus structured, however, gaps (as indicated by letter S in FIG. 8) tend to be formed between the thermistor element 2 and the insulating plate 8 because the film thickness of the comb-shaped electrodes 3 and 4 is not negligibly small. It now goes without saying that these gaps S affect adversely the thermal conduction from the exothermic body 1 to the insulating plate 8.

In order to address this problem, it has been known to insert silicone grease or an adhesive agent into the gaps S in order to improve the thermal conduction. Since thermal conductivity of silicone grease and adhesive agents is not much better than that of an air layer, however, it has remained difficult to provide an efficient heater capable of a large power output by taking full advantage of the exothermic characteristic.

### SUMMARY OF THE INVENTION

It is therefore an object of this invention to provide an exothermic body capable of efficiently conducting heat outputted from the surface of a thermistor element with positive temperature characteristic.

An exothenmic body embodying this invention, with which the above and other objects can be accomplished, may be characterized not only as having a pair of comb-shaped electrodes on one of the main surfaces of a planar thermistor element having positive temperature characteristic, but also wherein the film thickness of these comb-shaped electrodes is less than 10 μm. It is preferable to further provide terminal electrodes, baked onto side surfaces and the other of the main surfaces of the thermistor element and connected to the comb-shaped electrodes. It is further preferable that the comb-shaped electrodes comprise Ni, Al, Cr, Monel, an alloy thereof, or a layered structure including two or more kinds thereof.

An exothermic body according to this invention may be produced by forming an electrode film on the surfaces of a planar thermistor element with positive temperature characteristic and forming a pair of comb-shaped electrodes therefrom by an etching process. Explained more in detail, an electrode film may be formed by plating on the surfaces of the thermistor element and, after an etching resist is applied on this film in the form of the pair of comb-shaped electrodes, the portion of the film exposed from the etching resist is etched away, and the etching resist is finally removed to form the pair of comb-shaped electrodes on one of the main surfaces of the thermistor element. Alternatively, a plating resist may be placed on the thermistor element surface and, after the portion of the thermistor element surface exposed by this plating resist is plated to form the electrode film, the plating resist is removed to form the pair of comb-shaped electrodes. As still another method, the pair of comb-shaped electrodes may be formed by sputtering. Terminal electrodes are also baked onto side surfaces and the other of the main surfaces of the thermistor element, connected to the pair of comb-shaped electrodes. An exothermic body with an improved power output can be obtained by such a method according to this invention, with which the comb-shaped electrodes with reduced thickness can also be formed.

### BRIEF DESCRIPTION OF THE DRAWINGS

The accompanying drawings, which are incorporated in and form a part of this specification, illustrate embodiments of the invention and, together with the description, serve to explain the principles of the invention. In the drawings:

FIG. 1 is a diagonal view of an exothermic body according to a first embodiment of this invention after an etching resist has been applied during a course of its production;

FIG. 2 is a diagonal view of the exothermic body of FIG. 1 after an etching process has been carried out to form a pair of comb-shaped electrodes and the etching resist has been removed;

FIG. 3 is a sectional view of the exothermic body according to the first embodiment of this invention, taken along line 3-3 of FIG. 2;

FIG. 4 is a diagonal view of another exothermic body according to a second embodiment of this invention after a plating resist has been applied during a course of its production;

FIG. 5 is a diagonal view of the exothermic body of FIG. 4 after an electrode film has been formed by plating;

FIG. 6 is a graph for showing the relationship between the power output from an exothermic body and the film thickness of its comb-shaped electrodes;

FIG. 7 is a diagonal view of a prior art exothermic body; and

FIG. 8 is a sectional view of a portion of a heater using the exothermic body of FIG. 7, taken along line 8-8 of FIG. 7.

### DETAILED DESCRIPTION OF THE INVENTION

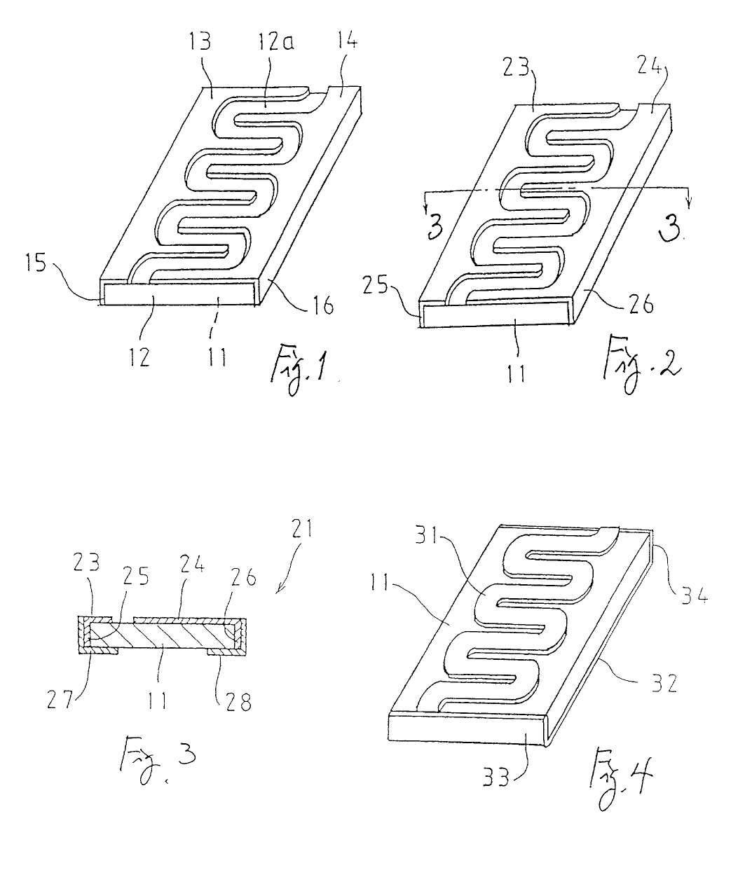

A method for producing an exothermic body according to this invention is described first with reference to FIGS. 1-3. A planar thermistor element 11 with positive temperature characteristic with size 30×40×1.0 mm is prepared, and all its surfaces are subjected to an electroless Ni-plating process to form an electrode film 12. Next, an etching resist 13 and 14 is applied in the form of a pair of comb-shaped electrodes on the electrode film 12 on one of the main surfaces of the thermistor element 11, as shown in FIG. 1. Next, an etching resist 15 and 16 is applied onto mutually opposite side surfaces of the thermistor element 11, and the portion of the electrode film 12 exposed by the etching resist 13, 14, 15 and 16 is removed by an etching process. The etching resist 13, 14, 15 and 16 are then removed to obtain a pair of comb-shaped electrodes 23 and 24 and side-surface electrodes 25 and 26 which are on the side surfaces and electrically connected to the comb-shaped electrodes 23 and 24, as shown in FIG. 2.

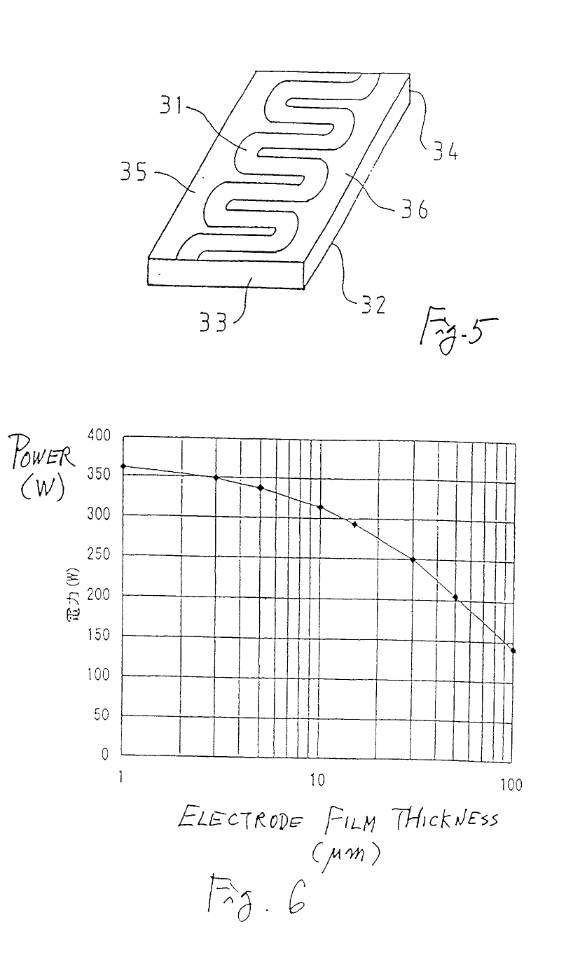

An exothermic body 21 shown in FIG. 3 is obtained further by applying an electro-conductive paste having silver as its main component from the other of the main surfaces to the side surfaces of the thermistor element 11 so as to cover the plated side-surface electrodes 25 and 26 and forming terminal electrodes 27 and 28 by baking to make connections to the pair of comb-shaped electrodes 23 and 24. In other words, the side-surface electrodes 25 and 26 are in electrically conductive relationship respectively with the pair of comb-shaped electrodes 23 and 24. Since the side-surface electrodes 25 and 26 are for the purpose of making the electrical connection dependable between the pair of comb-shaped electrodes 23 and 24 each having a plurality of mutually parallel solid fingers extending from a base part and the terminal electrodes 27 and 28, they may be replaced by any suitable connecting means.

The exothermic body 21, thus obtained, was used to form a heater (not shown) by placing, through silicone grease, an insulating plate 8 and a heat radiating member 9 on the same main surface of the exothermic body 21 where the pair of comb-shaped electrodes 23 and 24 are formed, as shown in FIG. 8. A frame with dimensions 30×40 mm was attached to the main surface of the heat radiating member 9, water was placed inside this frame, and an AC current of 100 V was passed through the exothermic body 21. The power required by the exothermic body 21 for bringing the water into boiling was 348 W. The resistance at normal temperature of this thermistor element 11 was 50 Ω, and its Curie temperature was 180° C.

Another method of producing an exothermic body according to this invention is described next with reference to FIGS. 4 and 5. A (first) plating resist 31 is applied to one of the main surfaces of a thermistor element (also indicated by numeral 11 for convenience) which is identical to the one described above with reference to FIGS. 1-3, such that a main surface of the thermistor element 11 will be exposed in the form of the comb-shaped electrodes. Next, a (second) plating resist 32 is applied to the other main surface of the thermistor element 11, and (third) plating resists 33 and 34 are applied to mutually opposite side surfaces of the thermistor element 11, connecting to the first plating resist 31. Next, an electrode film is formed by electroless Ni-plating on the surfaces of the thermistor element 11 wherein the plating resists 31, 32, 33 and 34 have been applied. A pair of comb-shaped electrodes 35 and 36 is thus formed, as shown in FIG. 5, where the surface of the thermistor element 11 was exposed, not being covered by the plating resists 31, 32, 33 and 34.

As the plating resists 31, 32, 33 and 34 are removed, another thermistor 11 is obtained with a pair of comb-shaped electrodes 23 and 24 on one of its main surfaces. Another exothermic body (not shown) is formed therefrom by adding terminal electrodes 27 and 28, as described above with reference to FIGS. 1-3.

A still another method according to a third embodiment of this invention is described next with reference to FIGS. 3 and 4. A thermistor element as used above (and hence also referenced by numeral 11) is provided, and the portions of one of its main surfaces indicated by numerals 31, 32, 33 and 34 in FIG. 4 are covered by a mask. Electrode films, each having Ni, Cr and Ag as its principal component, are sequentially formed by sputtering to form a pair of comb-shaped electrodes as shown in FIG. 2, each of a layered structure having three layers. The thickness of each comb-shaped electrode, according to a test experiment, was 1 μm.

Next, terminal electrodes (as shown at 27 and 28 in FIG. 3) are added by baking, as described above, to form another exothermic body (not shown) embodying this invention.

As a comparison example, another thermistor element, identical to those used above (hence also indicated by numeral 11), was used and a pair of comb-shaped electrodes was formed in the shape of the one shown at 23 and 24 by applying an electro-conductive paste having silver as its principal component by screen printing and baking processes. Next, terminal electrodes were added as described above to form a comparison example of exothermic body (not shown) shaped similarly to the one shown at 21 in FIG. 3. The thickness of the comb-shaped electrode was 30 μm.

Heaters were formed also by using the other exothermic bodies 21 according to the second and third embodiments of the invention and the comparison example and their outputs were measured. The results are shown in Table 1 below.

TABLE 1

| | | Film Thickness |
|---|---|---|
| | Output Power | of Comb-shaped |
| | (W) | Electrodes (μm) |
| First Embodiment | 348 | 3 |
| Second Embodiment | 348 | 3 |
| Third Embodiment | 360 | 1 |
| Comparison Example | 253 | 30 |

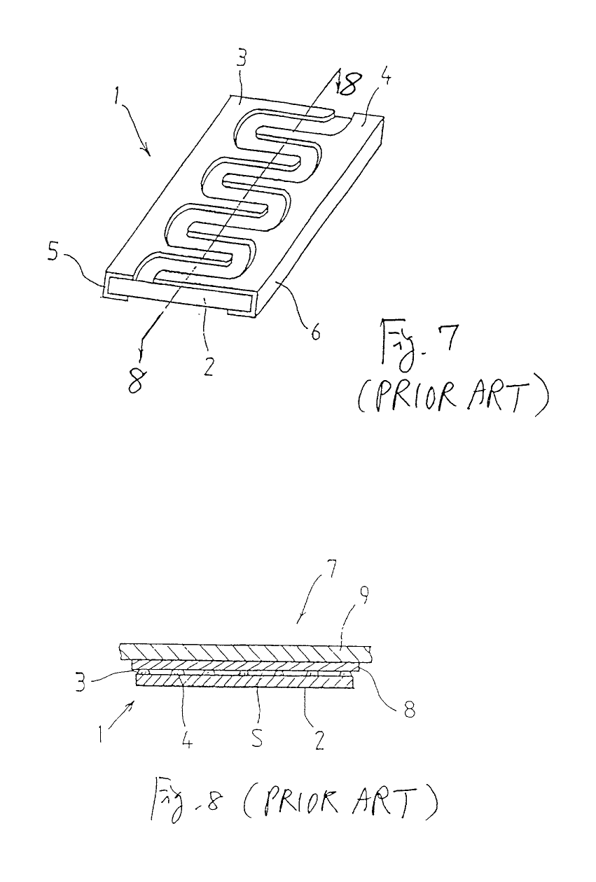

The relationship between the output power from the exothermic body and the film thickness of its comb-shaped electrodes was studied more in detail. Its results are shown in FIG. 6. It can be understood from Table 1 and FIG. 6 that the output power from the exothermic body decreases significantly as the film thickness of the comb-shaped electrodes exceeds 10 μm.

Although the invention has been described above with reference to only a limited number of examples, the scope of the invention is not intended to be limited by these examples. Although the use of Ni, Cr and Ag was disclosed, for example, use may be made of Ni, Cr, Ag, Monel, or any metal which can form an alloy with any of them and provide an ohmic contact with the thermistor element. The comb-shaped electrodes may be of a layered structure with a plurality of layers.

In summary, exothermic bodies according to this invention are characterized as having thin comb-shaped electrodes such that the heat from the thermistor element can be efficiently conducted to the heat radiating member. As a result, exothermic bodies with higher power can be provided. Such exothermic bodies can be produced by using a plating or sputtering method to form the comb-like film electrodes on the thermistor element such that thinner comb-shaped electrodes can be obtained. Thinner electrode films can be formed by sputtering and, if the comb-shaped electrodes are formed by a dry process, the characteristics of the thermistor elements are not adversely affected.

What is claimed is:

1. An exothermic body comprising:
a planar thermistor element with positive temperature characteristic, having a pair of mutually opposite main surfaces: and
a pair of comb-shaped electrodes formed on one of said main surfaces of said thermistor element, said comb-shaped electrodes being less than 10 μm in thickness and each having a plurality of mutually parallel solid fingers extending from a base part.

2. The exothermic body of claim 1 further comprising terminal electrodes formed on side surfaces and the other of said main surfaces of said thermistor element by baking, said terminal electrodes being each electrically connected to an associated one of said pair of comb-shaped electrodes.

3. The exothermic body of claim 2 wherein said comb-shaped electrodes comprise one selected from the group consisting of Ni, Al, Ag, Cr, Monel, and alloys thereof.

4. The exothermic body of claim 2 wherein said comb-shaped electrodes is of a layered structure with two or more layers each comprising one selected from the group consisting of Ni, Al, Ag, Cr, Monel, and alloys thereof.

5. A method of making an exothermic body, said method comprising the steps of:
forming an electrode film by plating on surfaces of a planar thermistor element with positive temperature characteristic; and
forming a pair of comb-shaped electrodes on one of main surfaces of said thermistor element by etching said electrode film, said comb-shaped electrodes each having a plurality of mutually parallel solid fingers extending from a base part.

6. The method of claim 5 further comprising the step of forming terminal electrodes on side surfaces and the other of said main surfaces of said thermistor element by baking, said terminal electrodes being each electrically connected to an associated one of said pair of comb-shaped electrodes.

7. The method of claim 6 wherein said comb-shaped electrodes comprise one selected from the group consisting of Ni, Al, Ag, Cr, Monel, and alloys thereof.

8. The method of claim 6 wherein said comb-shaped electrodes are of a layered structure with two or more layers each comprising one selected from the group consisting of Ni, Al, Ag, Cr, Monel, and alloys thereof.

9. A method of making an exothermic body, said method comprising the steps of:
forming an electrode film by plating on surfaces of a planar thermistor element with positive temperature characteristic; and
forming a pair of comb-shaped electrodes on one of main surfaces of said thermistor element by providing said electrode film with an etching resist in the shape of a pair of combs on said one main surface of said thermistor element, etching portions of said electrode film exposed by said etching resist, and removing said etching resist, said comb-shaped electrodes each having a plurality of mutually parallel solid fingers extending from a base part.

10. The method of claim 9 further comprising the step of forming terminal electrodes on side surfaces and the other of said main surfaces of said thermistor element by baking, said terminal electrodes being each electrically connected to an associated one of said pair of comb-shaped electrodes.

11. The method of claim 10 wherein said comb-shaped electrodes comprise one selected from the group consisting of Ni, Al, Ag, Cr, Monel, and alloys thereof.

12. The method of claim 10 wherein said comb-shaped electrodes are of a layered structure with two or more layers each comprising one selected from the group consisting of Ni, Al, Ag, Cr, Monel, and alloys thereof.

13. A method of making an exothermic body, said method comprising the steps of:
providing a planar thermistor element with positive temperature characteristic; and
forming a pair of comb-shaped electrodes on one of main surfaces of said thermistor element by providing plating resists at specified positions on said one main surface of said thermistor element, forming by plating an electrode film on portions of said one main surface of said thermistor element exposed by said plating resists and thereafter removing said plating resists, said comb-shaped electrodes each having a plurality of mutually parallel solid fingers extending from a base part.

14. The method of claim 13 further comprising the step of forming terminal electrodes on side surfaces and the other of said main surfaces of said thermistor element by baking, said terminal electrodes being each electrically connected to an associated one of said pair of comb-shaped electrodes.

15. The method of claim 14 wherein said comb-shaped electrodes comprise one selected from the group consisting of Ni, Al, Ag, Cr, Monel, and alloys thereof.

16. The method of claim 14 wherein said comb-shaped electrodes are of a layered structure with two or more layers each comprising one selected from the group consisting of Ni, Al, Ag, Cr, Monel, and alloys thereof.

17. A method of making an exothermic body comprising the steps of providing a planar thermistor element with positive temperature characteristic and forming by sputtering a pair of comb-shaped electrodes on one of main surfaces of said thermistor element, said comb-shaped electrodes each having a plurality of mutually parallel solid fingers extending from a base part.

18. The method of claim 17 further comprising the step of forming terminal electrodes on side surfaces and the other of said main surfaces of said thermistor element by baking, said terminal electrodes being each electrically connected to an associated one of said pair of comb-shaped electrodes.

19. The method of claim 18 wherein said comb-shaped electrodes comprise one selected from the group consisting of Ni, Al, Ag, Cr, Monel, and alloys thereof.

20. The method of claim 18 wherein said comb-shaped electrodes are of a layered structure with two or more layers each comprising one selected from the group consisting of Ni, Al, Ag, Cr, Monel, and alloys thereof.
